(19) United States
(12) Patent Application Publication
(10) Pub. No.: US 2020/0191952 A1
(43) Pub. Date: Jun. 18, 2020

(54) VEHICLE AND OBJECT DETECTION SYSTEM

(71) Applicant: Saddleye Inc., Plano, TX (US)

(72) Inventors: Sami Makinen, Littleton, CO (US); Christopher Stark, Plano, TX (US)

(21) Appl. No.: 16/713,321

(22) Filed: Dec. 13, 2019

Related U.S. Application Data
(60) Provisional application No. 62/779,084, filed on Dec. 13, 2018.
(60) Provisional application No. 62/882,706, filed on Aug. 5, 2019.

(51) Int. Cl. G01S 13/931; B60W 50/16; B60W 30/09; B60W 30/095; G01S 13/86; H04W 4/46; G01S 7/00

(52) U.S. Cl. CPC G01S 13/931; B60W 50/16; B60W 30/09; B60W 2556/65; G01S 13/865; H04W 4/46; G01S 7/003; B60W 30/0953

(57) ABSTRACT

Systems, methods, computing platforms, and storage media for detecting a potential collision with a vulnerable object are described. Exemplary implementations may include a detection system coupled to the vulnerable object comprising a main unit, the main unit comprising a power device, a housing, a central processing unit, an internal memory device or a storage device, at least one of an optical sensor, a laser, an accelerometer, and an alarm, a wireless transmitter for exchanging data with a first object, a computing device, or another vulnerable object, and a communication device for communicating with a radar unit or a computing device. The radar unit comprises one or more antennas and detects the first object using millimeter wave or Extremely High Frequency radio frequencies and transmits an indication of the first object to the main unit via the wireless transmitter or the communication device.

### PRIORITY AND CROSS REFERENCE TO RELATED APPLICATIONS

The present Application for Patent claims priority to U.S. Provisional Application No. 62/779,084 and U.S. Provisional Application No. 62/882,706, filed Dec. 13, 2018 and Aug. 5, 2019, respectively, and assigned to the assignee hereof. Both of these applications are hereby expressly incorporated by reference herein.

### FIELD OF THE DISCLOSURE

The present disclosure relates to vehicle-mounted object detection systems. In particular, but not intended to limit the disclosure, the present disclosure relates to a detection system that may warn users of physical dangers present during operation of the vehicle.

### BACKGROUND

Recent advancements in automated transportation systems and autonomous automobiles has facilitated in creating safer roadways for their occupants. While occupants of such transportation systems and automobiles have benefited from this technology, users of other forms of transportation, such as bikes, motorcycles, scooters, and even pedestrians, have little to no protection from these autonomous forms of transportation. In some cases, warning systems utilized in autonomous automobiles are not easily transferable to other forms of transportation, primarily due to the complexity and size of such systems. In such cases, users of other forms of transportation, including pedestrians, are left without safety features commonly seen in autonomous modes of transportation, and travel unprotected in an age of digital roadways.

### SUMMARY OF THE DISCLOSURE

Disclosed herein is a system for making users of forms of transportation more visible to autonomous vehicles and providing these users with safety and warning notifications and other relevant information while operating the system.

The present invention is generally directed to optimizing safety in vulnerable forms of transportation, including pedestrians, and riders of two or three-wheeled vehicles, such as mopeds, scooters, motorcycles, bicycles, etc. In some cases, users of such forms of transportation may lack digital safety features commonly utilized in automobiles and trucks. Warning systems and situational information are crucial components for informing riders and pedestrians of risks present on roadways. The present disclosure serves to alleviate these problems by utilizing an Advanced Rider Assistance Safety System (ARASS) that uses a connected vehicle system installed or mounted on vulnerable forms of transportation such as bicycles, motorized two or three-wheeled vehicles, electrified scooters, wheelchairs, or even skateboards, hoverboards, or longboards. Additionally, or alternatively, the ARASS may be applied to a person traveling on foot. In some cases, the ARASS system may serve to make the users of these forms of transportation more visible to autonomous vehicles. Further, the users of these forms of transportation may be provided with safety notifications and/or warning information. Thus, the systems, methods, and apparatuses of the present disclosure may serve to enhance road safety.

Some embodiments of the disclosure may be characterized as a detection system coupled to a vulnerable object comprising a main unit, the main unit comprising an enclosure. In some embodiments, the main unit may also comprise one or more hardware processors configured by machine-readable instructions, a central processing unit (CPU), and one or more of an internal memory device and a storage device, a wireless transmitter for exchanging data with at least one of a first object, a computing device, and another vulnerable object, a communication device for communicating with at least one of a radar unit and a computing device, wherein the communication devices communicates with the at least one the radar unit and the computing device using at least one of Bluetooth, Bluetooth Low Energy (BLE), Wi-Fi, cellular, and Near Field Communication (NFC), wherein the radar unit comprises one or more antennas and at least one of a millimeter wave (mmW) and Extremely High Frequency (EHF) transceiver for detecting the first object based at least in part on millimeter wave or Extremely High Frequency radio frequencies, and wherein the radar unit transmits an indication of the first object to the main unit via the wireless transmitter or the communication device, and at least one of an optical sensor, a laser, an accelerometer, and an alarm.

In some embodiments, the vulnerable object comprises a person or is a transportation unit selected from a group consisting of a bicycle, a motorcycle, a moped, a scooter, skateboard, roller blades, roller skates, and hoverboard.

In some embodiments, the first object comprises a vehicle. In further embodiments, the indication comprises a potential collision between the vulnerable object and the vehicle. In some embodiments, the wireless transmitter comprises a vehicle-to-vehicle (V2V) transmitter for transmitting the indication to the vehicle.

In some embodiments, the central processing unit receives one or more of accelerometer data, mm-wave radar data, optical data, laser data, time data, and global positioning data and provides real-time object detection and tracking based on the same.

In some embodiments, the main unit comprises a graphics processing unit (GPU). In further embodiments, the GPU renders images based in part on data received from the CPU.

In some embodiments, the main unit relays real-time data to the computing device via the communication device, wherein the computing device comprises one or more of a smartphone, a laptop, a tablet, and an augmented near-eye device.

In further embodiments, the vehicle object detection system comprises an edge computer, wherein the computing device further comprises a long-range low-latency connectivity device for transmitting information pertaining to the vulnerable object, and wherein the information comprises at least a vulnerable object type and a location of the vulnerable object to the edge computer.

In some embodiments, the main unit further comprises one or more sensors, the one or more sensors including at least one of a positioning sensor, a visual sensor, a movement sensor, and an infrared (IR) sensor.

In some embodiments, the accelerometer comprises an alternating current (AC)-response accelerometer, a direct current (DC)-response accelerometer, or a gravity sensor (G-sensor) accelerometer.

In further embodiments, the CPU receives accelerometer data and identifies that a collision has occurred based at least in part on detecting that an acceleration or deceleration has exceeded a threshold.

In some embodiments, the wireless transmitter transmits an indication of the collision to emergency services or an emergency contact upon identifying that the collision has occurred. In further embodiments, the main unit identifies a crash severity level associated with the collision based at least in part on analyzing one or more of accelerometer data, optical data, and radar data.

In some embodiments, the main unit further comprises a graphics processing unit (GPU). In some embodiments, the optical sensor obtains visual data, and the CPU or GPU of the main unit accesses a detection grid and warning system and analyzes the visual data in association with the detection grid and warning system.

In further embodiments, the optical sensor comprises at least one of a rear-facing, a side-facing, and a forward-facing optical sensor, and the main unit identifies at least one of an approach angle and a velocity of the first object based at least in part on the visual data.

In some embodiments, the alarm provides a warning to a user of the vulnerable object, and the warning comprises one or more of an audible warning, a haptic warning, and a visual warning.

In some embodiments, the main unit transfers obtained data to a cloud-based database utilizing a deep learning algorithm. In some embodiments, the main unit identifies at least one of an angle of approach and a velocity of an approaching object based at least in part on information obtained from the laser.

In some embodiments, the enclosure or the main unit further comprises at least one of forward-facing and rear-facing Light Emitting Diodes (LEDs), and wherein the forward-facing or rear-facing LEDs provide a visual warning.

In some embodiments, the main unit alters a course of the vulnerable object based at least in part on detecting a potential collision with the first object. In further embodiments, the altering comprises at least one of engaging one or more brakes of the vulnerable object, adjusting a steering of the vulnerable object, and engaging a forward propulsion system of the vulnerable object.

In some embodiments, the first object comprises an approaching object. In some embodiments, the main unit maps object detection data comprising a velocity and a location of the approaching object onto an object detection grid comprising one or more detection zones, and wherein the main unit identifies a warning or a danger level based at least in part on the mapping.

In some other embodiments, a non-transitory, tangible computer readable storage medium, encoded with processor readable instructions, the instructions being executable by one or more processors to perform a method for detecting a potential collision with a vulnerable object is described. In some embodiments, the method comprises coupling a vehicle object detection system to the vulnerable object, wherein the vehicle object detection system comprises a main unit. In some embodiments, the main unit comprises an enclosure, a power device for supplying power to the main unit, a central processing unit (CPU), a wireless transmitter, a communication device, a radar unit comprising one or more antennas and at least one of a millimeter wave (mmW) and an Extremely High Frequency (EHF) transceiver, and one or more of an internal memory device, a storage device, an optical sensor, a laser, an accelerometer, and an alarm.

In some embodiments, the method comprises configuring the radar unit to detect the potential collision based at least in part on millimeter wave or Extremely High Frequency radio frequencies. In further embodiments, the method comprises configuring the communication device to communicate with one or more of the radar unit, the wireless transmitter, and a computing device using at least one of Bluetooth, Bluetooth Low Energy (BLE), Wi-Fi, cellular, and Near field Communication (NFC). In further embodiments, the method comprises configuring the wireless transmitter to exchange data with at least one of a first object, an edge computer, and another vulnerable object. In further embodiments, the method comprises transmitting, from the radar unit, an indication of the potential collision to the main unit via the wireless transmitter or the communication device. In further embodiments, the method comprises exchanging, from the wireless transmitter or the main unit, the indication of the potential collision with the first object with at least one of the first object and the edge computer, based at least in part on the transmitting.

In some other embodiments, a method for detecting a potential collision with a vulnerable object is described. In some embodiments, the method comprises coupling a vehicle object detection system to the vulnerable object, wherein the vehicle object detection system comprises a main unit. In some embodiments, the main unit comprises an enclosure, a power device for supplying power to the main unit, a central processing unit (CPU), a wireless transmitter, a communication device, a radar unit comprising one or more antennas and at least one of a millimeter wave and an Extremely High Frequency transceiver, and one or more of an internal memory device, a storage device, an optical sensor, a laser, an accelerometer, and an alarm.

In some embodiments, the method comprises configuring the radar unit to detect the potential collision based at least in part on millimeter wave or Extremely High Frequency radio frequencies. In further embodiments, the method comprises configuring the communication device to communicate with one or more of the radar unit, the wireless transmitter, and a computing device using at least one of Bluetooth, Bluetooth Low Energy (BLE), Wi-Fi, cellular, and Near field Communication (NFC). In further embodiments, the method comprises configuring the wireless transmitter to exchange data with at least one of a first object, an edge computer, and another vulnerable object. In further embodiments, the method comprises transmitting, from the radar unit, an indication of the potential collision to the main unit via the wireless transmitter or the communication device. In further embodiments, the method comprises exchanging, from the wireless transmitter or the main unit, the indication of the potential collision with the first object with at least one of the first object and the edge computer, based at least in part on the transmitting.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 illustrates a diagrammatic representation of an exemplary embodiment of a main unit of a vehicle detection system in accordance with embodiments described herein;

FIG. 2 illustrates an exemplary embodiment of a radar unit of a vehicle detection system in accordance with embodiments described herein;

FIG. 3 illustrates an exemplary object detection grid of a vehicle detection system utilizing an optical device in accordance with embodiments described herein;

FIG. 4 illustrates an exemplary object detection grid of a vehicle detection system utilizing a mm-wave radar device in accordance with embodiments described herein;

FIG. 5 illustrates a diagrammatic representation of one embodiment of a computer system within which a set of instructions can be executed for causing a device to perform or execute one or more of the aspects and/or methodologies of the present disclosure;

FIG. 6 comprises a front view of an example of an enclosure and main unit illustrating various features of a vehicle detection system in accordance with embodiments described herein;

FIG. 7 comprises a rear view of an example of an enclosure and main unit illustrating various features of a vehicle detection system in accordance with embodiments described herein.

### DETAILED DESCRIPTION

The words “for example” is used herein to mean “serving as an example, instance, or illustration.” Any embodiment described herein as “for example” or any related term is not necessarily to be construed as preferred or advantageous over other embodiments. Additionally, a reference to a “device” is not meant to be limiting to a single such device. It is contemplated that numerous devices may comprise a single “device” as described herein. Furthermore, references herein to a VO may also relate to a vehicle and/or a pedestrian.

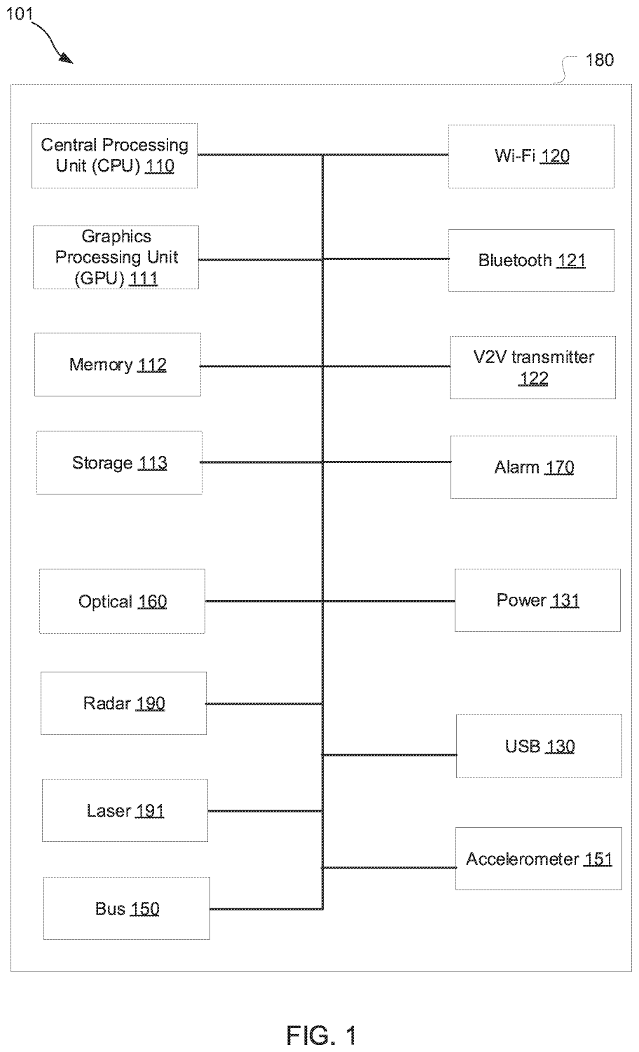

FIG. 1 illustrates components comprising an exemplary embodiment of a main unit 101 of a vehicle detection system. In some examples, main unit 101 may comprise a computer or a computer type device, and may comprise a central processing unit (CPU) 110, a graphics processing unit (GPU) 111, an internal memory device 112, a storage device 113, a Wi-Fi communication device 120, a Bluetooth device 121, a vehicle-to-vehicle (“V2V”) transmitter, referred to herein as a V2V transmitter 122, a Universal Serial Bus (USB) interface 130, a power device 131, a connectivity bus 150, an accelerometer 151, an optical device 160, an alarm 170, and an enclosure 180. In some embodiments, the main unit may additionally comprise a millimeter wave (mmW) or Extremely High Frequency (EHF) radar device 190 and/or a laser device 191. One such laser device 191 may comprise the laser, as described herein.

In some cases, the CPU 110 of the main unit 101 may perform computational requirements of the main unit 101. Such computations may include calculating real-time detection of objects, as described herein. Such object detection may be used to warn users of the main unit 101 of objects approaching the user. One such user may comprise a user of a vulnerable object (VO). It should be noted that main unit 101 may be installed on the VO (e.g., manually installed via a coupling device such as, but not limited to, a bolt-nut system, hook and loop fasteners, or any other coupling device known in the art) or within (e.g., as hardware—at least part of circuit board, or solely as software in an existing circuit board/computing device) a pre-installed VO vehicle object detection system. As previously described, the VO may be a pedestrian, or may comprise a motorcycle, bicycle, moped, scooter, etc., or any rider of such a vehicle

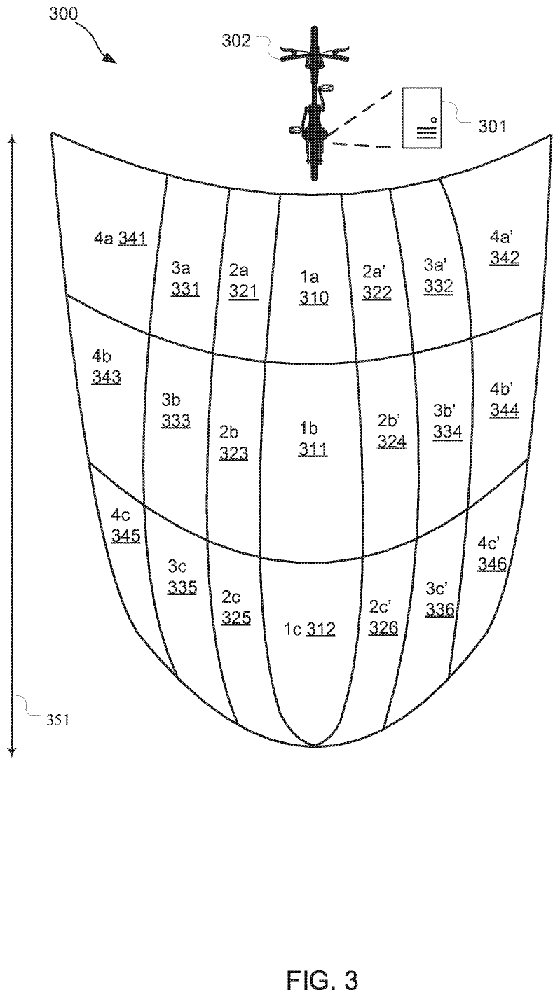

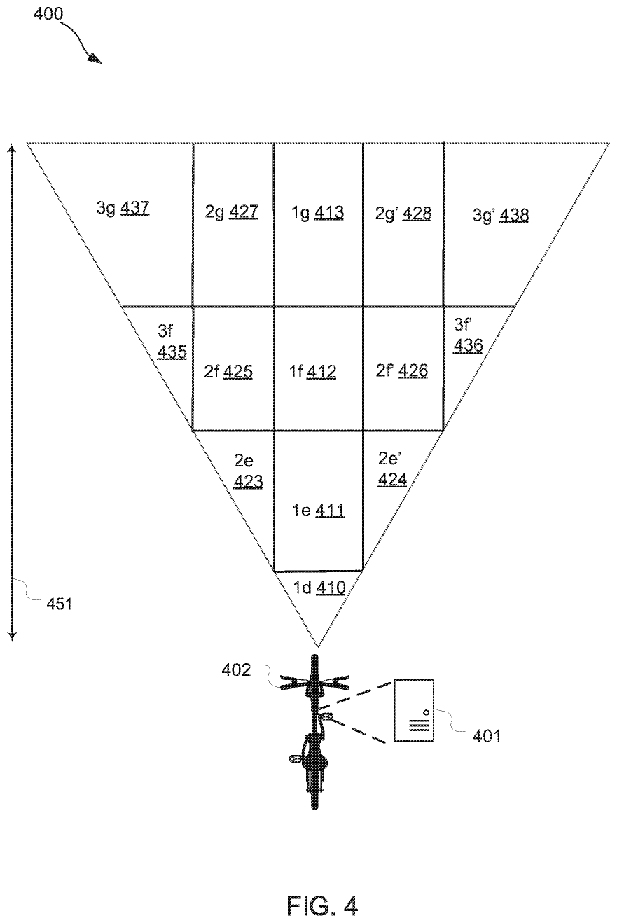

In some examples, computations may utilize object detection grids and warning systems as illustrated and described in relation to FIGS. 3 and 4, below. Computations by the central processing unit 110 may further utilize data including, but not limited to, accelerometer data, mm-wave radar data, optical data, laser data, time data, global positioning data, or other types of data known in the art applicable for computing real-time object detection.

In some embodiments, the central processing unit 110 may also communicate with the graphics processing unit 111. The graphics processing unit 111 may render images based upon data received from the central processing unit 110 or any other device shown in FIG. 1 or elsewhere as described herein. In some cases, the graphical processing unit 111 may enable such data to be viewable on a display, also referred to herein as a screen (such as, but not limited to, a Liquid Crystal Display (LCD), plasma, or a Light-Emitting Diode (LED) display). In some examples, such a screen may be incorporated into the design of the main unit 101.

In some other examples, the data from the graphics processing unit 111 or any other device seen in FIG. 1 may additionally, or alternatively, be communicated to a computing device through the Wi-Fi communication device 120 and/or the Bluetooth device 121. One such computing device may comprise a mobile device such as, but not limited, to, a smartphone, a smartwatch or other wearable device, and a heads-up display. The above list is not meant to be exhaustive and other computing devices known in the art or yet to be developed are also contemplated. The Wi-Fi communication device 120 may communicate using, but not limited to, 2.4 GHz and/or 5 GHz Wi-Fi technologies. In some other cases, the Wi-Fi communication device may communicate over broadband cellular networks such as, but not limited to, third generation (3G), fourth generation (4G), fifth generation (5G), or any other networks.

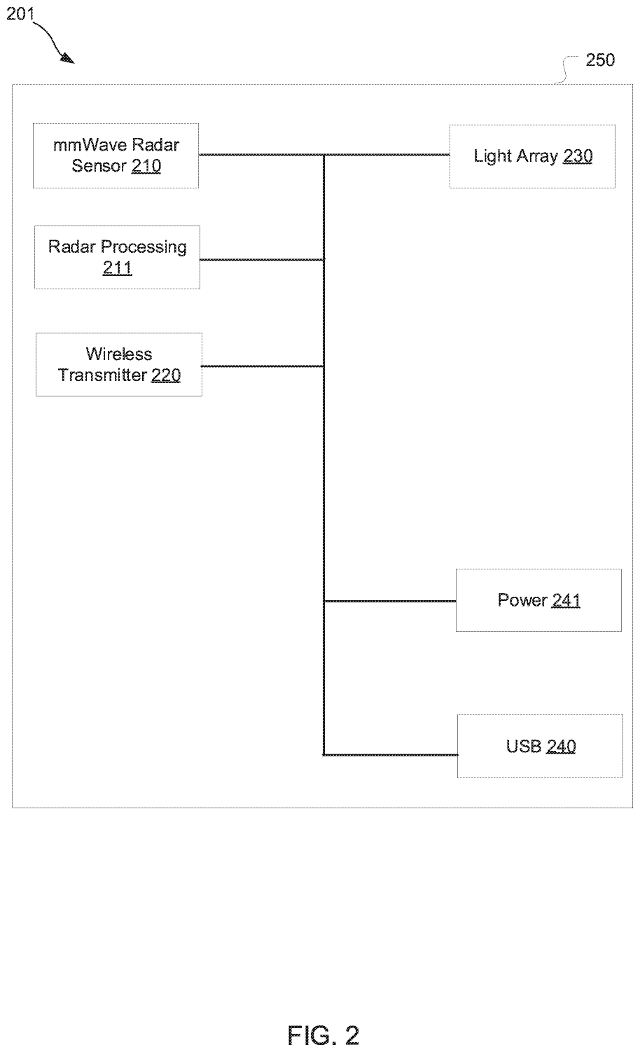

In some cases, the Bluetooth device 121 may communicate using Bluetooth, or Bluetooth low energy (BLE) communication methods. In some embodiments, the Wi-Fi communication device 120 and Bluetooth device 121 may be the same physical device. In some embodiments, the Wi-Fi communication device 120 and/or Bluetooth device 121 may be part of an ad hoc network. In one embodiment, the main unit 101 may share and/or relay the real-time data obtained by one or more components of the vehicle detection system to a computing device via the Wi-Fi communication device 120 and/or the Bluetooth device 121. The Wi-Fi communication device 120 and the Bluetooth device 121 may also communicate with a wireless transmitter 220 of radar unit 201, as further discussed in relation to FIG. 2.

The internal memory device 112 of the main unit 101 may temporarily or permanently store a variety of data obtained by the vehicle detection system including, but not limited to, accelerometer data, date/time data, radar data, laser data, and/or video imagery data recorded by the optical device 160. The internal memory device 112 may be a semiconductor, magnetic, or an optics-based memory device. The data may be stored (i.e., permanently or temporarily) using a loop algorithm-based method, or any other applicable method. In some other cases, long-term storage of the main unit 101's data may be accomplished using the storage device 113.

Similar to the internal memory device, the storage device 113 may comprise a semiconductor, magnetic, or optical based storage device. In some embodiments, the data stored on the storage device 113 and/or internal memory device 112 may be used for post-incident analysis. For instance, if the user associated with the vehicle detection system is involved in a collision or an accident, the data may be accessed to determine a cause of the collision or accident. In one such example, the internal memory device 112 may communicate with the central processing unit 110 and the graphics processing unit 111 to map time stamp data (e.g. hh:mm:ss) from a running clock with optical data obtained through the optical device 160. Optical data may comprise images and/or video. If the accelerometer 151 detects an impact (e.g., as determined by an % decrease in velocity of the VO in a specified time), time stamp data from the running clock, along with the optical data from the optical device 160 may be stored on the internal memory device 112 and/or the storage device 113 for a period of time extending from before the detected collision (e.g. 5 mins, 1 min, 30 s, 10 s, or any other period) to a period of time after the detected collision (e.g. 1 min, 30 s, 10 s, 3 s, or any other period). This timestamped information may then be used to determine the exact time when a collision occurred, as well as events leading up to the collision, in a post-incident analysis. In some examples, the optical data related to the accident (i.e., before and/or after the accident) may be downloaded by the user or law enforcement to a computing device. Optionally, the main unit 101 may automatically upload the optical data related to the accident to a cloud-based database via, for example, a connected computing device with access to the cloud-based database, such as a smart phone in communication with the main unit 101. In one such embodiment, the computing device may be pre-registered with the cloud-based database.

As previously stated, the main unit 101 may comprise the V2V transmitter 122. The V2V transmitter 122 may be used to exchange (i.e., transmit and receive) data with other vehicles. The other vehicles may be referred to herein as a first object and may comprise an automobile or any other type of vehicle described herein or otherwise known or unknown at the time of filing. It is also contemplated that the first object may comprise a stationary object such as, but not limited to, a parked vehicle, a building, or any other stationary object. The first object may also comprise a pedestrian. In some embodiments, the V2V transmitter 122 may be used to notify the user of the first object of the location of the main unit 101/VO. In some other examples, the V2V transmitter may also be used to notify a user of the main unit 101/VO of a location of the first object. In some cases, such communications may occur over a Radio Frequency (RF) network, an Infrared (IR) network, or another network utilized for V2V communication. In some aspects, V2V communication may enable other vehicles to take necessary actions to prevent a collision between the vehicle and the user associated with the main unit 101. All references to V2V herein may also include vehicle-to-infrastructure (“V2I”), where appropriate.

In some cases, main unit 101 may identify the type of vehicle, if any, associated with the main unit 101, or may identify the VO as a pedestrian. In some cases, such an identification may be based in part on data collected from one or more sensors, including visual sensors, movement sensors, accelerometers, or even audio/sound sensors. In some other cases, the user of the vehicle object detection system comprising the main unit 101 may select the type of vehicle on which the vehicle detection system is mounted, for instance, using a computing device via an application or accessing a website. In some cases, a computing device may act as a long-range low-latency connectivity device and may transmit the vehicle type and main unit 101 position to, for example, a unified edge computer data center. Such location mapping may provide awareness data of other vehicles near the main unit 101. Furthermore, such awareness data may be relayed to the main unit's display, e.g., the previously described screen(s), providing full transparency of the surrounding environment to the user.

The main unit 110 may comprise a connectivity bus 150 and an accelerometer 151. The connectivity bus 150 may be used to connect onboard sensors to the main unit 101. This may include positioning sensors, visual sensors, movement sensors, or other types of applicable sensors. Such sensors may comprise third-party sensors that comprise a portion of the VO or a computing device. Connectivity bus 150 may be in communication with accelerometer 151. Accelerometer 151 may be an Alternating Current (AC)-response or a Direct Current (DC)-response accelerometer, or another type of accelerometer. In some embodiments, the accelerometer 151 may utilize a Gravity Sensor (G-sensor) design. In some cases, velocity and acceleration data of the main unit may be captured and recorded by the accelerometer 151. In some other cases, the velocity and acceleration data captured by the accelerometer may be recorded and stored in the internal memory device 112 and/or the storage device 113. In yet other cases, this data may be provided to a computing device in communication with the main unit 101 via a live data stream and/or may be provided to the edge or cloud computing device.

In some circumstances, the accelerometer may also be used to detect an impact to the main unit 101, the user of main unit 101, and/or the VO, which may be indicative of a collision. For example, the accelerometer may detect an acceleration or a deceleration exceeding a threshold amount that would indicate that the main unit and/or user has been involved in a collision. Such an acceleration or deceleration may trigger the main unit or another component to begin recording and storing time stamping and optical data storage for post-incident analysis. As discussed above, the data may be stored and accessed to provide information pertaining to the collision in a post-incident analysis (e.g. the force of the collision, speed of the user during the crash, etc.). If the collision is deemed to be severe enough, for instance, based on the acceleration or deceleration data, optical data, radar data, etc., the vehicle detection system may automatically send a notification to relevant emergency services or an emergency contact. In some other cases, if the severity level of the collision is below a threshold, the vehicle detection system may request user confirmation prior to notifying emergency services.

In some embodiments, the accelerometer 151 may provide acceleration data for image stabilization purposes of, for example, optical data from the optical device 160. In some aspects, the deployment of image stabilization may enhance the functionality of the vehicle detection system, for instance, while operating on rough or uneven terrain.

The main unit 101 may comprise one or more optical devices 160. In some cases, optical devices 160 may obtain visual data that may be utilized by the CPU 110 and/or GPU 111 in association with the detection grid and warning system as illustrated in and discussed in relation to FIG. 3. Each optical device 160 may comprise one or more optical lenses, fisheye lenses, or any other type of optical lens. In some embodiments, the one or more optical lenses of each optical device 160 may have protective films, which may reduce lens damage and increase durability (e.g., in rain, snow, etc.). In some cases, the optical device 160 may comprise up to a two-hundred-and-seventy-degree field of view. However, more or less field of view degree amounts may be present in some embodiments. Optical device 160 may be capable of recording optical data in a variety of resolutions and frame rates (e.g., 720p resolution at 15 frames per second (fps), 1080p at 15 fps, 1080p at 30 fps, etc.). In some cases, the resolution and frame rate may be selected by the user using the main unit or accessing a computing device application or website.

In some examples, the optical device may be arranged in a rear-facing configuration, as showing in FIG. 3, enabling the approach angle and velocity of an object approaching from the rear to be detected by the main unit 101. In some embodiments, optical devices may also be arranged in a side facing, or forward-facing position to detect objects in a manner similar to that of the rear-facing embodiment. The optical device 160 may communicate the optical data to the CPU 110 and/or GPU 111.

As previously mentioned, the main unit 101 may comprise the USB interface 130, power device 131, alarm 170 and enclosure 180. In some cases, the enclosure may also be referred to as a housing. The USB interface 130 may be used for charging the main unit and/or transferring data between the main unit 101 and a computing device. One power device 131 may comprise a rechargeable battery. In some other cases, the power device 131 may comprise a device that provides power from a source other than rechargeable batteries, such as a fuel cell, a solar cell, or a non-rechargeable replaceable battery (e.g., AA battery, AAA battery, D battery, etc.). The alarm 170 may comprise an audible alarm that may warn the user of a potential collision. The sound emitted by the alarm 170 may comprise a series of audible beeps and/or voice warnings. In some examples, the sound emitted by the alarm 170 may vary in intensity (i.e., volume) based on the danger level. The alarm 170 may be initiated according to the discussion in relation to FIGS. 3 and 4, below. The enclosure or housing 180 may surround and/or house internal components of the main unit 110, thus protecting the components of main unit 101 from physical forces and natural elements. It is contemplated that all items disclosed herein with reference to the main unit 110 may refer to one or more main unit components, as seen in FIG. 1 The enclosure 180 may be comprised of one or more of a variety of materials such as, but not limited to, polymeric materials (such as Polyvinyl chloride (PVC)), metal, ceramic, rubber, and/or other suitable materials.

The main unit 101 may comprise features enabling coupling to or mounted on a transportation unit. One such mounting feature may comprise a supplied mounting bracket. The mounting bracket may be used to mount the main unit 101 onto a variety of surfaces of a vehicle, including, but not limited to, handlebars, columns and/or supports, body, seat, or any other mounting surface. In some cases, the main unit 101 may also be designed to be coupled to a person. The mounting bracket may mount the main unit 101 on the rear or front of a VO or vehicle, or even the sides of the VO. These locations may be referred to herein as rear facing, forward facing, and side facing, respectively. The mounting bracket may be composed of a variety of materials including polymeric materials (such as PVC), metal, ceramic, rubber, or other suitable materials.

The main unit 101 may be communicate with a variety of computing devices. In some examples, such computing devices may serve to assist in the operation, computation, and adaptation of the vehicle object detection system. As previously described, the Wi-Fi communication device 120 and/or the Bluetooth device 121 may support connectivity (i.e., communication) between the main unit 101 and a computing device such as, but not limited to, smart phones (e.g. android and iOS devices), tablets, computers, augmented near-eye devices (i.e., Cross Reality (XR) technology devices), or any other computing device. Connectivity between the main unit and a computing device may facilitate exchange of data between the computing device and the main unit's central processing unit 110, graphics processing unit 111 or any other component of the main unit 101.

In some embodiments, a user of the vehicle object detection system may have access to a Graphical User Interface (GUI), which may enable the user to configure a computing device associated with the vehicle detection system. One computing device may comprise a portion of the main unit. For example, one such main unit computing device may comprise one or more hardware processors configured by machine-readable instructions, a central processing unit, and one or more of an internal memory device and a storage device. Other computing devices associated with the vehicle detection system may comprise smart phones (e.g. android and iOS devices), tablets, computers, augmented near-eye devices (i.e., Cross Reality (XR) technology devices), or any other computing device as described herein. The GUI may be located on the computing device or main unit 101. Further, the GUI may enable the user of main unit to receive audible, haptic, and/or visual warnings, as illustrated in, and discussed in relation to FIGS. 3 and 4. In some examples, the warning may be in the form of an audible warning (such as beeps or a voice recording) emitted from the computing device or from a headset worn by the user and connected to the computing device. In some other examples, a haptic warning could be conveyed to the user via a wrist band, handlebar surface mount, or another haptic device communicatively connected to the vehicle detection system. In some embodiments, the warning could be a visual warning displayed on the GUI or on a user's augmented near-eye smart-device. In some cases, the visual warning may be shown using onboard LEDs. In some embodiments, the onboard LEDs may be oriented in different directions, and each direction may have a different color mapping. The GUI may also allow the user to operate and/or control the vehicle detection system (e.g. start/stop/pause of the vehicle detection system) from the computing device.

Connectivity between the main unit 101 and computing device(s) may also enable the integration of various software-based applications into the vehicle detection system. The vehicle detection system may also collect road or trail condition data via, for example, the optical device 160 or other sensors. In some cases, this data may be used in conjunction with navigation or other applications, which may assist a user in avoiding certain road or trail conditions and/or provide detours to the user. In some circumstances, this data may be shared anonymously with these applications. Road or trail condition data may also be used to highlight the presence of gravel, snow, ice, sand, water, or road damage (if any).

The connectivity of the main unit 101 and computing device(s) may also enable the user to transfer data between the vehicle detection system and the computing device. Such a transfer may enable storage of the vehicle detection system data on the computing device. In some embodiments, the processing capabilities of the computing device may be utilized to process the vehicle detection data (i.e., in addition to the central processing unit 110 of the main unit 101).

In some examples, the vehicle detection system data may also be transferred to a cloud-based database. Such a database may be crowd-sourced by, for example, various users of generally similar, similar or substantially similar vehicle detection systems. In some cases, continuous accuracy improvements may be supported through deep learning algorithms running on the cloud-based database. For instance, the parameters of the vehicle detection system may be optimized using such deep learning or machine learning algorithms of the cloud-based database.

In some cases, the vehicle detection system data, including the optical, accelerometer, laser, and/or radar data obtained by the vehicle detection system may be uploaded and provided to a crowd sourced data platform. In some other cases, simulated learning data sets uploaded onto a cloud-based server may facilitate in optimizing detection and false detections through parameterized set detection accuracy. This may allow for the vehicle detection system's parameters to be continuously improved by cloud-based deep learning platforms leading to a more accurate vehicle object detection system.

In some examples, the cloud-based system may communicate the new parameters back to the main unit 101. In such cases, the vehicle detection system may update its current parameters with the newly received parameters, thus fine-tuning accuracy. In one embodiment, the main unit of the vehicle object detection system may tune the depth and/or width of its vehicle detection grids, as further discussed in FIGS. 3 and 4, below. In other embodiments, the warning notifications may be tuned in a similar manner, also as discussed in reference to FIGS. 3 and 4, below. In some aspects, optimization of the vehicle detection grids and warning notifications through crowd-sourced deep-learning may occur automatically without user input. In some other cases, user input may be requested prior to any updates.

In addition to fine-tuning warning and spatial parameters of the vehicle detection system, the cloud-based deep learning database may allow for the main unit 101 of vehicle detection system to adjust parameters based in part on the driving and/or traveling habits of a specific user. For example, the main unit 101 may upload data pertaining to a user of the main unit 101 to the cloud-based deep learning database. In some cases, these parameters may be updated or optimized based in part on the uploaded data. The optimization may be based upon a type of vehicle used by the user (e.g., bicycle, moped, foot, skateboard, hoverboard, etc.) and/or driving habits of the user (e.g., tendency to accelerate, change lanes, etc.). Thus, in some aspects, a profile including a vehicle type, driving habits, driving style, etc. may be created for a user of the main unit 101. Furthermore, if the user switches the type of vehicle on which the main unit 101 is mounted, or a different user with a vastly different driving habit or style utilizes the main unit 101, the cloud-based database may create a new profile or update the profile stored on the main unit 101. In other words, a personalized vehicle detection system utilizing user-specific, in addition to, or potentially rather, than vehicle-specific, data may be supported through the use of the cloud-based service, which may also serve to increase the accuracy of the system.

In some embodiments, the main unit 101 may include a mm-wave radar device 190. One mm-wave radar device 190 may comprise a millimeter wave (mmW) or Extremely High Frequency (EHF) transceiver (i.e., transmitter/receiver). The mm-wave radar device 190 may be used to detect potential collisions based at least in part on mmW or EHF radio frequencies. Specifically, the main unit 101 may analyze the reflections of mmW or EHF radio frequency waves emitted from the mm-wave radar device 190. In some examples, the mm-wave radar device 190 may be used in place of, or in addition to, the optical device 160. In some cases, the mm-wave radar device 190 may be an example of the mm-wave radar sensor 210, further described in FIG. 2. It should be noted that any discussion of the functionality and design of the mm-wave radar sensor 210 may be applied to the mm-wave radar device 190 and vice-versa, where applicable.

In some embodiments, the main unit 101 may comprise a laser device 191, which may also be utilized to identify potential collisions and conduct other computations or other calculations described herein, together with the radar device or other devices herein or without one or more such devices. In some cases, laser beams reflected from an approaching object may be analyzed by the main unit 101 or its components, in order to detect and identify potential collisions. In one example, laser device 191 may utilize Light Detection and Ranging (LIDAR) technology, although different laser technologies may also be implemented. LIDAR may refer to a remote sensing technique where light in the form of a pulsed laser is used to measure ranges or distances between objects. In some cases, real-time object type identification data captured or obtained by the laser device 191 may be processed by the main unit or one of its sub-components, such as the CPU or GPU, based on which a potential collision may be identified. Additionally, like the optical device 160 and mm-wave radar device 190, the laser device 191 may also be used to identify the angle of approach and velocity of an approaching object, together with one or more of the other devices or alone.

In some embodiments, a plurality of main units 101 may be used in conjunction with a single transportation unit or user. In some cases, the plurality of main units 101 may be oriented in different directions (i.e., forward-facing, rear-facing, side-facing, etc.) and may be in communication with each other (i.e., wired or wireless). For example, a vehicle may have a front main unit 101 and rear main unit 101 where the front main unit 101 is oriented in a forward direction and the rear main unit 101 is oriented in a backward direction. Further, the front main unit 101 may contain forward-facing onboard LEDs with one color mapping (e.g., green or yellow), and the rear main unit 101 may contain rear-facing onboard LEDs with a different color mapping (e.g., red or blue). The forward-facing and rear-facing LEDs may provide a visual warning and may vary in intensity or magnitude depending on the danger level. For example, different numbers of LEDs may be illuminated, or LEDs may emit light with varying intensities or colors based on a danger level for the user of the main unit. In some cases, onboard LEDs may provide a visual warning to the user. Additionally, or alternatively, the onboard LEDs may provide a visual warning to other vehicles or pedestrians.

In some embodiments, the main unit 101 may interface with a docking station. The docking station may provide power to the power device 131. In some other cases, the docking station may comprise a fixed communication connection (e.g., via USB or THUNDERBOLT). Optionally, the docking station may be connected to a computing device and may provide a means for the main unit 101 to communicate with the computing device. In some examples, this fixed connection may be used in addition to, or in lieu of, the wireless connection between a computing device and the main unit 101 discussed above. In some cases, the computing device may be used to configure the main unit 101 (i.e., through either a fixed or wireless connection). In some embodiments, the power device 131 may be a rechargeable battery, and the docking station may provide power to the battery via a wireless charging system. In some other embodiments, the power device may be a solar cell, a fuel cell, or a non-rechargeable battery. In yet other embodiments, the power device may utilize a dynamo hub, which is an example of an energy-generating hub. In such cases, the main unit and its components may be powered via the motion (i.e., rotation of the wheels or tires) of the transportation unit or the user.

In some embodiments, the vehicle detection system may be configured to provide a warning (e.g., an auditory, haptic, or visual warning) to a user of the main unit, for instance, if the transportation unit or vehicle departs from a lane on a road. In some cases, such lane departures may be detected using the optical device 160 or through other lane detection systems.

In some embodiments, one or more actions may be initiated following warnings provided by the vehicle detection system. For example, if the vehicle detection system detects a dangerous situation, such as a potential collision, the vehicle detection system may not only provide a warning to the user but may also alter the heading of the transportation unit or the vehicle to avoid the collision. Initiated actions may include engaging the brakes of the vehicle, adjusting the steering of the vehicle, or engaging the forward propulsion system of the vehicle. In one such embodiment, engaging the forward propulsion system comprises . . . .

FIG. 2 illustrates an exemplary radar unit 201 of a vehicle detection system. As illustrated, radar unit 201 may comprise a mm Wave radar sensor 210, a radar processing component 211, a wireless transmitter 220, a light array 230, a USB-interface 240, a power device 241, and an enclosure 250.

In some embodiments, the mm-wave radar sensor 210 of radar unit 201 may comprise a transceiver utilizing mm-Wave or EHF radio wave technology. In some cases, EHF radio waves may comprise wavelengths in the thirty to three hundred gigahertz (GHz) range, but more specifically, in the 76 to 81 GHz range. EHF radio waves spanning these bands of the electromagnetic spectrum may have wavelengths ranging from ten to one millimeter (mm). In some cases, EHF radio waves may be utilized for short-range object detection due to their wide bandwidths, high transmission speeds, and most notably their short range, which serves to reduce interference for users of other communication systems in the vicinity. In some cases, the mm Wave radar sensor 210 may be deployed in vehicle object detection systems mounted on terrestrial transportation devices such as bicycles, motorized two or three-wheeled vehicles, electrified scooters, skateboards, hoverboards, and persons. EHF waves transmitted and received by the mm-wave radar sensor 210 may allow for quick response times (e.g., <100 ms) when directed towards an object (e.g., a vehicle) in proximity with the source of the EHF waves. That is, an approaching object may be detected by analyzing the EHF waves reflected off of that object. In such cases, a user may be issued a warning response about the approaching object.

In some examples, EHF waves may be paired with or used in conjunction with an object detection grid and warning system, as illustrated and further described in FIGS. 3 and/or 4. In one such embodiment, the mmWave radar sensor 210 may be configured for a view of 120 degrees from its center. However, in some embodiments, the view may be greater or less than this amount. In one embodiment, the mmWave radar sensor 210 may comprise dual, sixty-degree field of view mm-wave radar antennas. However, in some other embodiments, more (or less) antennas may be used, with higher (or lower) degree field of views. One mmWave radar sensor 210 may be capable of detecting objects such as, but not limited to, vehicles up to two hundred and fifty (250) feet from the source of the EHF waves. In other embodiments, it is contemplated that the range may be greater or less than this distance. For example, one such detection range may extend from a few meters (e.g., 2 m) to 180 m. The mmWave radar sensor may be sensitive enough to accurately detect objects on a scale of ten centimeters (e.g., 10 cm, 20 cm, etc.) at a distance of around 120 m. The mm-wave radar sensor 210 may be mounted in a forward-facing direction (e.g. the direction of movement of the user) to detect objects in front of the vehicle and/or user. However, in some embodiments, the mm-wave radar sensor 210 may be rear or side facing to detect objects to the rear and side of the vehicle and/or user.

The mmWave radar sensor 210 may communicate with the radar processing component 211 using one or more buses similar to the bus 150 seen in FIG. 1. The radar processing component 211 may process the radar data received from the mmWave radar sensor 210. For instance, the radar processing component 211 may convert the data into usable forms for other components of the main unit 101, such as the CPU or GPU of the main unit, or to other computing devices as discussed herein.

The radar unit 201 may comprise a wireless transmitter 220. The wireless transmitter 220 may be used to pair the radar unit 201 to the main unit 101 through the Bluetooth device 121 or Wi-Fi communication device 120 or otherwise enable communications between the two devices. The pairing of/communication between the radar unit's wireless transmitter 220 and the main unit 101 may enable real-time alignment of the radar data obtained by the mmWave radar sensor 210 with video object data obtained by the optical device 160 of the main unit, and acceleration data obtained by the accelerometer 151. The information in the various data sets may be used to optimize the accuracy of the vehicle object detection system. For example, a first object angle of approach or velocity of the first object may be verified using this data via the central processing unit 110. In some cases, this processing may be followed by the main unit triggering any combination of audio, visual, or haptic alarms to the user, enabling the user to avoid the potential collision.

The radar unit 201 may additionally comprise a light array 230, USB interface 240, and a power device 241. The light array 230 may provide light for the user of the VO. The light array 230 may comprise one or more LED's arranged in a circular geometry, however, in some embodiments, other types of lights arranged in different geometries may be used. The USB interface 240 may be used for charging and/or powering the radar unit 201. In some other cases, the USB interface 240 may also be used for hard-wired data transfer to/from the radar unit 201. In some examples, the radar unit 201 may be debugged through communication with the USB interface 240. The power device 241 may comprise a rechargeable battery type device. Alternatively, the power device 241 may comprise non-rechargeable batteries, a fuel cell, a solar cell, etc.

The radar unit 201 may be designed to be coupled or mounted to the vehicle using a variety of mounting methods. One such mounting methods may be accomplished using a supplied mounting bracket. For instance, the mounting bracket may be used to mount the radar unit onto a variety of surfaces that includes, but is not limited to, handlebars of vehicles, columns and/or supports of vehicles, bodies of vehicles, seats of vehicles, persons, or other mounting surfaces. The mounting bracket may mount the radar unit 201 in a rear facing, forward facing, or side facing orientation. The radar unit 201 may be housed in an enclosure 250. The enclosure 250 may be used to house the components of the radar unit 201 into a single unit. The enclosure 250 may protect the components of radar unit 201 from physical and natural forces, as well as environmental factors. The enclosure 250 may be composed from a variety of materials including polymeric materials (such as PVC), metals, ceramics, rubber, or other suitable materials. It is contemplated that the main unit 101 and radar unit 201 may be incorporated into a single device.

FIG. 3 illustrates an object detection grid 300 that may be utilized by a vehicle detection system. The object detection grid 300 may be utilized by the main unit 301 mounted on a vehicle 302 (a bicycle in FIG. 3). As disclosed herein, the main unit may also be mounted on a personal transportation unit, a person, or a person's attire. The main unit 301 seen in FIG. 3 may comprise an example of the main unit 101, as described with regards to FIG. 1 and elsewhere herein. The vehicle 302 may be a variety of vehicles, including bikes, scooters, and other personal transportation devices, such as hoverboards, longboards, skateboards, etc. In some embodiments, the vehicle may comprise a person (e.g., pedestrian, person in wheelchair, etc.). The vehicle detection grid 300 may utilize the methods, systems, and apparatuses of main unit 101, including, but not limited to, the optical device 160, mm-wave radar device 190, and/or laser device 191 of main unit 101, as discussed in relation to, and illustrated in, FIG. 1. The main unit 301 may identify and detect dangerous situations, such as, but not limited to, a potential collision event that may threaten the physical safety of the user of vehicle 302. The identification and detection may be accomplished using a variety of techniques including analyzing optical data, radar data, laser data, and/or accelerometer data. Some examples of potential collision events may include cross-traffic collisions, vehicle door opening collisions, left/right rear angle collisions, pedestrians and/or animals in the field of travel, accidental veering into a different lane occupied by traffic or parked cars, etc.

The object detection grid 300 may comprise detection zones associated with varying levels of danger organized in a grid format. In one such embodiment, the object detection grid 300 may be used to determine an alarm type and a warning and danger level to be issued to a user of vehicle 302 that is based upon the level of danger the object presents to the user. The grid 300 may be used in association with data received from, for example, the optical device of main unit 301, which may supply real-time video data to another component of the main unit 301, such as, but not limited to, the CPU or GPU. In some examples, the optical device, CPU, or GPU may identify an object type associated with an approaching object (also referred to herein as a first object) in the video data. For instance, video processing algorithms stored on main unit 301 may be executed, causing one or more hardware processors of main unit 301 to identify the object type. In some embodiments, data related to the approaching object may also comprise radar data obtained by the mm-wave radar sensor 190 and/or laser data obtained by the laser device 191, as further described in FIG. 1.

In some examples, the real-time object detection may provide data such as, but not limited to, an angle of approach of the first object and velocity of the first object. Approaching object data may be mapped onto the object detection grid 300. The object detection grid 300 may then assign an appropriate level of danger of the detected object and inform the user of the vehicle 302 of that danger level via an appropriate warning issued for the detected object. The warning of the detected object may be accomplished through an alarm comprising an audible warning, a visual warning, or a haptic warning by the main unit 301, as discussed herein. The warning may also be conveyed via a computing device. In one embodiment, the warning may warn the user of an impending danger and enable the user to prevent an accident by avoiding the first object.

In one embodiment, an approaching object may be detected by the optical device of main unit 301. The main unit 301 may determine the type of first object approaching (e.g. a car). The main unit 301 may then determine the proximity of the object to the vulnerable object/vehicle 302 and the velocity of the first object. The main unit 301 may then determine the level of danger of the object based upon mapping the location, velocity, acceleration, and/or direction of travel of the first object on the object detection grid 300. If the level of danger of the object exceeds a threshold amount, the main unit 301 may emit an audible warning to warn the user of vehicle 301. In some other cases, the main unit 301 may communicate the warning to a computing device. In such cases, the warning may be conveyed to the user through a GUI, heads-up display, or a haptic device, allowing the user to avoid the accident.

In some cases, the object detection grid 300 may be divided into one or more detection zones. The detections zones, in combination with the velocity, acceleration, direction of travel, and/or type of object, may be used to determine the level of warning issued to the user of vehicle 301. In some circumstances, the detection zones may be geometrically oriented such that the grid comprises four levels of width and three levels of length. However, in some embodiments, more (or less) levels of width and/or length may be present. As discussed in relation to FIG. 1, the object detection grid 300 may comprise up to a two-hundred- and seventy-degree angle field of view as seen from the main unit 101. Furthermore, optimization of the detection zones and/or the level of warning issued may be accomplished through the use of deep-learning algorithms incorporating crowd-sourced data sets. The detection zones may also be optimized to fit the user's specific locomotion/vehicle type, VO operating habits, and style. The detection zones may be categorized into four levels of danger which may be primary, secondary, tertiary, and quaternary levels of danger.

In FIG. 3, the object detection grid 300 may be divided into a plurality of detection zones. As illustrated, object detection grid 300 may comprise detection zone 1a 310, detection zone 1b 311, detection zone 1c 312, detection zone 2a 321, detection zone 2a′ 322, detection zone 2b 323, detection zone 2b′ 324, detection zone 2c 325, detection zone 2c′ 326, detection zone 3a 331, detection zone 3a′ 332, detection zone 3b 333, detection zone 3b′ 334, detection zone 3c 335, detection zone 3c′ 336, detection zone 4a 341, detection zone 4a′ 342, detection zone 4b 343, detection zone 4b′ 344, detection zone 4c 345, and detection zone 4c′ 346. The detection zones may be geometrically arranged such that detection zone 4a 341, detection zone 3a 331, detection zone 2a 321, detection zone 1a 310, detection zone 2a′ 322, detection zone 3a′ 332, and detection zone 4a′ 342 all comprise similar or substantially similar horizontally-oriented widths.

Additionally, detection zone 4b 343, detection zone 3b 333, detection zone 2b 323, detection zone 1b 311, detection zone 2b′ 324, detection zone 3b′ 334, and detection zone 4b′ 344 may all comprise similar or substantially similar horizontally-oriented widths. In some examples, detection zone 4c 345, detection zone 3c 335, detection zone 2c 325, detection zone 1c 312, detection zone 2c′ 326, detection zone 3c′ 336, and detection zone 4c′ 346 may also comprise similar or substantially similar horizontally-oriented widths.

Similarly, the detection zones may be geometrically arranged such that detection zone 4a 341, detection zone 4b 343, and detection zone 4c 345 may all comprise similar or substantially similar vertical lengths. Additionally, detection zone 3a 331, detection zone 3b 333, and detection zone 3c 335 may all comprise similar or substantially similar vertical lengths. Additionally, detection zone 2a 321, detection zone 2b 323, and detection zone 2c 325 may all comprise similar or substantially similar vertical lengths. Additionally, detection zone 1a 310, detection zone 1b 311, and detection zone 1c 312 may all comprise similar or substantially similar vertical lengths.

Additionally, detection zone 2a′ 322, detection zone 2b′ 324, and detection zone 2c′ 326 may all comprise similar or substantially similar vertical lengths. Additionally, detection zone 3a′ 332, detection zone 3b′ 334, and detection zone 3c′ 336 may all comprise similar or substantially similar vertical lengths. Additionally, detection zone 4a′ 342, detection zone 4b′ 344, and detection zone 4c′ 346 may all comprise similar or substantially similar vertical lengths.

In some examples, the overall vertical length 351 of detection grid 300 may be 250 feet, but as discussed herein, the vertical length 351 may be greater or smaller) in length in some embodiments. It is contemplated that the geographic dimensions of the detection zones may encompass a set (or fixed) area. It should be noted, however, that this area may be adjusted and/or optimized, as discussed herein.

As discussed herein, the level of warning that is issued by main unit 301 may be based on four categorizations of danger levels for the various detection zones. The primary level of danger may be allotted to the detection zones with the highest levels of danger. The secondary level of danger may be less dangerous than the primary level of danger, but more than the tertiary level of danger. The tertiary level of danger may be less dangerous than the secondary level of danger, but more dangerous than the quaternary level of danger. The quaternary level of danger may be less dangerous than the third level of danger and may be allotted to detection zones with the lowest level of danger severity within the grid.

In some embodiments, the level of danger may determine the warning level issued by the vehicle detection system. Warnings may be issued for objects in the primary, secondary, and tertiary levels of danger. In some examples, warnings may, or may not, be issued for objects lying within the quaternary level of danger. The primary level of danger detection zones may comprise detection zone 1a 310, detection zone 1b 311, detection zone 1c 312, detection zone 2a 321, detection zone 2b 323, and detection zone 2c 325. The secondary level of danger detection zones may comprise detection zone 2a′ 322, detection zone 2b′ 324, detection zone 2c′ 326, detection zone 3a 331, detection zone 3b 333, and detection zone 3c 335. The tertiary level of danger detection zones may comprise detection zone 3a′ 332, detection zone 3b′ 334, detection zone 3c′ 336, detection zone 4a 341, detection zone 4b 343, and detection zone 4c 345. The quaternary level of danger detection zones may comprise detection zone 4a′ 342, detection zone 4b′ 344, and detection zone 4c′ 346.

FIG. 4 illustrates an object detection grid 400 of a vehicle detection system. The object detection grid 400 may utilize a radar unit 401 which may be mounted on a vehicle 402. The radar unit 401 may be the same as radar unit 201. The vehicle 402 may be a variety of vehicles, including bikes, scooters, and other personal transportation devices. In some embodiments, the vehicle may be replaced by a person (e.g., pedestrian, person in a wheelchair or motorized chair, etc.). The vehicle detection grid 400 may utilize the methods, systems, and apparatuses of radar unit 201, including the mmWave radar sensor 210 of radar unit 201, as discussed in relation to, and illustrated in FIG. 2. The radar unit 401 and/or components in communication with the radar unit 401 may identify and detect dangerous situations that may threaten users of vehicle 402. Such dangerous situations include, but not limited to, cross-traffic collisions, vehicle door opening collisions, and left/right angle collisions (e.g., when the user crosses or accidentally veers into automobile lanes).

The object detection grid 400 may be regarded as a grid comprising one or more detection zones associated with varying danger levels. Further, the warning or danger level issued to the user may be based in part on mapping the velocity and location of the object onto the grid. The mm-wave radar sensor of radar unit 401 may provide real-time EHF wave object detection and may incorporate the mm-wave radar processing algorithms of radar unit 201 to identify the object type. The real-time object detection of the radar unit 401 may provide analytical data such as, but not limited to, the angle of approach of the object and velocity of the object. The EHF wave data may be mapped onto the object detection grid 400. The object detection grid 400 may then assign the level of danger to the detected object. The level of danger may then determine the warning level issued for the detected object. The warning of the detected object may be issued by the main unit 101 (not shown) in communication with the radar unit 401. For example, the main unit 101 may issue an audible warning as discussed in relation to main unit 101 in FIG. 1. The warning may also be accomplished by a computing device, as discussed in relation to main unit 101 in FIG. 1. This warning may provide the user with an awareness of the danger, as well as the potential to avoid the object and prevent an accident.

For example, an approaching object may be detected by the mm-wave radar sensor of radar unit 401. The radar unit 401, CPU, or GPU may then determine the type of object (e.g. a car) approaching the user of radar unit 401. Further, the radar unit 401 may determine the proximity of the object to the vehicle 402 and the velocity of the object. The radar unit 401 may also determine the level of danger of the object based upon mapping the object data on the object detection grid 400. If the level of danger of the object exceeds a threshold amount, the radar unit 401 may communicate the same to the main unit or the CPU of the main unit. In some circumstances, the main unit may then emit an audible warning to warn the user of vehicle 402. In some other cases, the main unit may communicate the identified potential collision to a computing device that may additionally, or alternatively, warn the user through a GUI or haptic device. The user of radar unit 401 may then be able to avoid the accident.

Similar to object detection grid 300 of FIG. 3, the object detection grid 400 may be divided into detection zones (i.e., detection zone 1d 410, detection zone 1e 411, detection zone 2e 423, detection zone 2e′ 424, detection zone 2f 425, detection zone if 412, detection zone 2f′ 426, detection zone 3f 435, detection zone 3f′ 436, detection zone 3g 437, detection zone 2g 427, detection zone 1g 413, detection zone 2g′ 428, and detection zone 3g′ 438). Further, the detection zones, in combination with the velocity of the object, may determine the level of warning issued to the user of vehicle 401. The detection zones may be geometrically oriented such that the grid comprises a plurality of levels of width and length. As discussed with regards to FIGS. 2 and 3, the system may support optimization of the detection zones and/or the warning levels issued, which may be accomplished through deep-learning algorithms incorporating crowd-sourced data (i.e., similar to that of object detection grid 300 in FIG. 3).

The object detection grid 400 may comprise multiple detection zones. The detection zones may be geometrically arranged such that some detection zones comprise similar or substantially similar horizontal widths. Additionally, or alternatively, some detection zones may comprise similar or substantially similar vertical lengths. The overall vertical length 451 of detection grid 400 may be 250 feet, but as discussed in relation to FIG. 1, this dimension may vary in different embodiments. Additionally, as described with regards to FIGS. 1, 2, and 3, the geographic dimensions of the detection zones may be of a set (or fixed) area, however the area may be adjusted or optimized based on information gathered about the user of the radar unit or main unit. It should be noted that the detection zones may be categorized into varying levels of danger, similar to those of object detection grid 300 in FIG. 3.

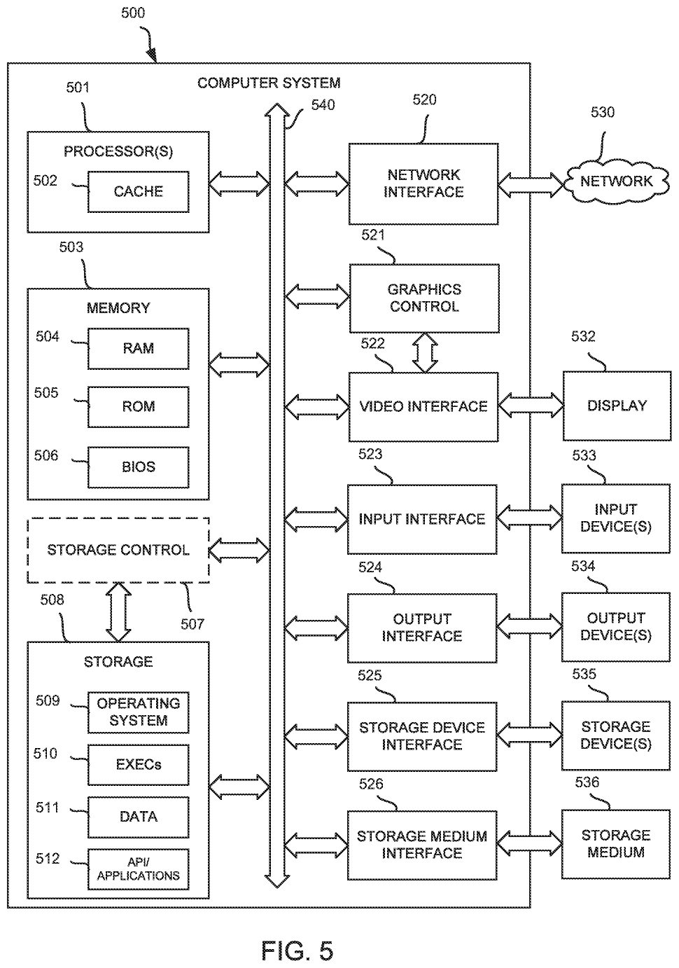

In addition to the specific embodiments described herein, the systems and methods described herein can be implemented in a computer system such as, but not limited to, computer system 500 of FIG. 5.

FIG. 5 illustrates a diagrammatic representation of one embodiment of a computer system 500, within which a set of instructions can execute for causing a device to perform or execute any one or more of the aspects and/or methodologies of the present disclosure. The components in FIG. 5 are examples only and do not limit the scope of use or functionality of any hardware, software, firmware, embedded logic component, or a combination of two or more such components implementing particular embodiments of this disclosure. Some or all of the illustrated components can be part of the computer system 500. For instance, the computer system 500 can be a general-purpose computer (e.g., a laptop computer) or an embedded logic device (e.g., an FPGA), to name just two non-limiting examples.

Moreover, the components may be realized by hardware, firmware, software or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted herein.

Computer system 500 includes at least a processor 501 such as a central processing unit (CPU) or a graphics processing unit (GPU) to name two non-limiting examples. Any of the subsystems described throughout this disclosure could embody the processor 501. The computer system 500 may also comprise a memory 503 and a storage 508, both communicating with each other, and with other components, via a bus 540. The bus 540 may also link a display 532, one or more input devices 533 (which may, for example, include a keypad, a keyboard, a mouse, a stylus, etc.), one or more output devices 534, one or more storage devices 535, and various non-transitory, tangible computer-readable storage media 536 with each other and/or with one or more of the processor 501, the memory 503, and the storage 508. All of these elements may interface directly or via one or more interfaces or adaptors to the bus 540. For instance, the various non-transitory, tangible computer-readable storage media 536 can interface with the bus 540 via storage medium interface 526. Computer system 500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 501 (or central processing unit(s) (CPU(s))) optionally contains a cache memory unit 532 for temporary local storage of instructions, data, or computer addresses. Processor(s) 501 are configured to assist in execution of computer-readable instructions stored on at least one non-transitory, tangible computer-readable storage medium. Computer system 500 may provide functionality as a result of the processor(s) 501 executing software embodied in one or more non-transitory, tangible computer-readable storage media, such as memory 503, storage 508, storage devices 535, and/or storage medium 536 (e.g., read only memory (ROM)). Memory 503 may read the software from one or more other non-transitory, tangible computer-readable storage media (such as mass storage device(s) 535, 536) or from one or more other sources through a suitable interface, such as network interface 520. Any of the subsystems herein disclosed could include a network interface such as the network interface 520. The software may cause processor(s) 501 to carry out one or more processes or one or more steps of one or more processes described or illustrated herein. Carrying out such processes or steps may include defining data structures stored in memory 503 and modifying the data structures as directed by the software. In some embodiments, an FPGA can store instructions for carrying out functionality as described in this disclosure. In other embodiments, firmware includes instructions for carrying out functionality as described in this disclosure.

The memory 503 may include various components (e.g., non-transitory, tangible computer-readable storage media) including, but not limited to, a random-access memory component (e.g., RAM 504) (e.g., a static RAM “SRAM”, a dynamic RAM “DRAM, etc.), a read-only component (e.g., ROM 505), and any combinations thereof. ROM 505 may act to communicate data and instructions unidirectionally to processor(s) 501, and RAM 504 may act to communicate data and instructions bidirectionally with processor(s) 501. ROM 505 and RAM 504 may include any suitable non-transitory, tangible computer-readable storage media. In some instances, ROM 505 and RAM 504 include non-transitory, tangible computer-readable storage media for carrying out a method. In one example, a basic input/output system 506 (BIOS), including basic routines that help to transfer information between elements within computer system 500, such as during start-up, may be stored in the memory 503.

Fixed storage 508 is connected bi-directionally to processor(s) 501, optionally through storage control unit 507. Fixed storage 508 provides additional data storage capacity and may also include any suitable non-transitory, tangible computer-readable media described herein. Storage 208 may be used to store operating system 509, EXECs 510 (executables), data 511, API applications 512 (application programs), and the like. Often, although not always, storage 508 is a secondary storage medium (such as a hard disk) that is slower than primary storage (e.g., memory 503). Storage 508 can also include an optical disk drive, a solid-state memory device (e.g., flash-based systems), or a combination of any of the above. Information in storage 508 may, in appropriate cases, be incorporated as virtual memory in memory 503.

In one example, storage device(s) 535 may be removably interfaced with computer system 500 (e.g., via an external port connector (not shown)) via a storage device interface 525. Particularly, storage device(s) 535 and an associated machine-readable medium may provide nonvolatile and/or volatile storage of machine-readable instructions, data structures, program modules, and/or other data for the computer system 500. In one example, software may reside, completely or partially, within a machine-readable medium on storage device(s) 535. In another example, software may reside, completely or partially, within processor(s) 501.

Bus 540 connects a wide variety of subsystems. Herein, reference to a bus may encompass one or more digital signal lines serving a common function, where appropriate. Bus 540 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 500 may also include an input device 533. In one example, a user of computer system 500 may enter commands and/or other information into computer system 500 via input device(s) 533. Examples of an input device(s) 533 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 533 may be interfaced to bus 540 via any of a variety of input interfaces 523 (e.g., input interface 523) including, but not limited to, serial, parallel, game port, USB, FIREWIRE, THUNDERBOLT, or any combination of the above.

In particular embodiments, when computer system 500 is connected to network 530, computer system 500 may communicate with other devices, such as mobile devices and enterprise systems, connected to network 530. Communications to and from computer system 500 may be sent through network interface 520. For example, network interface 520 may receive incoming communications (such as requests or responses from other devices) in the form of one or more packets (such as Internet Protocol (IP) packets) from network 530, and computer system 500 may store the incoming communications in memory 503 for processing. Computer system 500 may similarly store outgoing communications (such as requests or responses to other devices) in the form of one or more packets in memory 503 and communicated to network 530 from network interface 520. Processor(s) 501 may access these communication packets stored in memory 503 for processing.

Examples of the network interface 520 include, but are not limited to, a network interface card, a modem, and any combination thereof. Examples of a network 530 or network segment 530 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 530, may employ a wired and/or a wireless mode of communication. In general, any network topology may be used.

Information and data can be displayed through a display 532. Examples of a display 532 include, but are not limited to, a liquid crystal display (LCD), an organic liquid crystal display (OLED), a cathode ray tube (CRT), a plasma display, and any combinations thereof. The display 532 can interface to the processor(s) 501, memory 503, and fixed storage 508, as well as other devices, such as input device(s) 533, via the bus 540. The display 532 is linked to the bus 540 via a video interface 522, and transport of data between the display 532 and the bus 540 can be controlled via the graphics control 521.

In addition to a display 532, computer system 500 may include one or more other peripheral output devices 534 including, but not limited to, an audio speaker, a printer, and any combinations thereof. Such peripheral output devices may be connected to the bus 540 via an output interface 524. Examples of an output interface 524 include, but are not limited to, a serial port, a parallel connection, a USB port, a FIREWIRE port, a THUNDERBOLT port, and any combinations thereof.

In addition, or as an alternative, computer system 500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory tangible computer-readable storage medium known in the art. An exemplary non-transitory tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

It is contemplated that one or more of the components or subcomponents described in relation to the computer system 500 shown in FIG. 5 such as, but not limited to, the network 530, processor 501, memory, 503, etc., may comprise a cloud computing system. In one such system, front-end systems such as input devices 533 may provide information to back-end platforms such as servers (e.g. computer systems 500) and storage (e.g., memory 503). Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users may operate software located on back-end servers through the use of a front-end software application such as, but not limited to, a web browser.

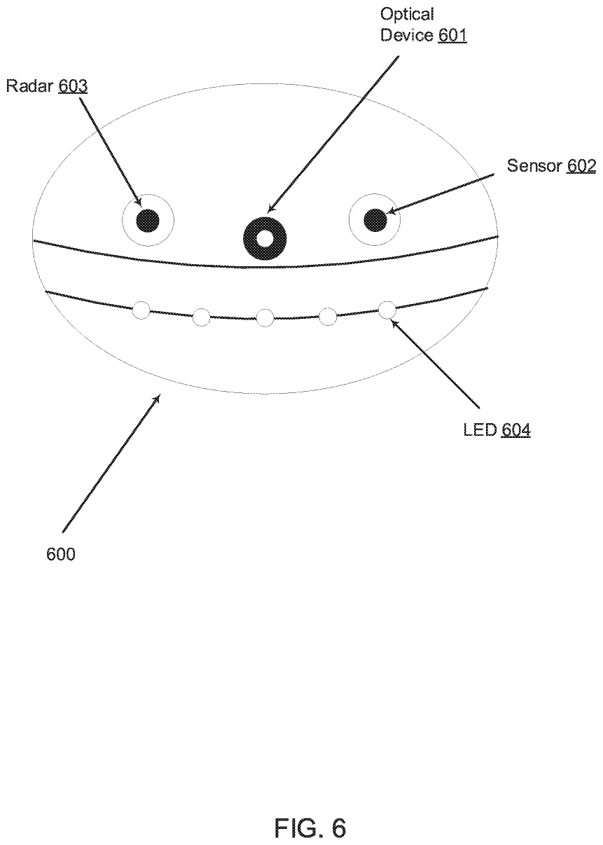

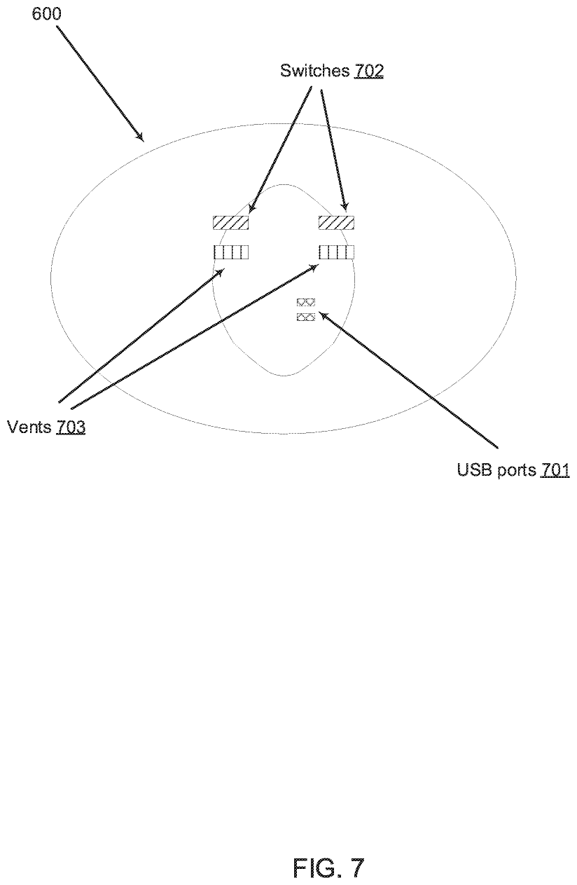

FIGS. 6 and 7 are illustrations displaying various angles (i.e., front and rear, respectively) of a vehicle detection system comprising a main unit 600.

For instance, FIG. 6 illustrates a front view of main unit 600. As shown, main unit 600 may comprise an optical device 601 (e.g., a camera including one or more optical lenses), one or more sensors 602 (e.g., mmW radar sensor, another optical sensor, laser sensor, infrared (IR) sensor, etc.), radar 603, and one or more LEDs 604. In some examples, all the components of main unit 600 may be enclosed within an enclosure or housing. Further, the main unit 600 of FIG. 6 may be an example of main unit 101 as described in relation to FIG. 1. In some examples, the one or more LEDs 604 of main unit 600 may be dual-color LEDs, such as, but not limited to, amber and red colors. It is further contemplated that the plurality of LEDs 604 may be placed in a specific design/shape, such as, but not limited to, an arc.

Further, the dual-color LEDs may function to provide a warning to one or more persons or vehicles within view of the dual-color LEDs. For example, the LEDs may flash sequentially to indicate that a vehicle or person on which the main unit 600 is mounted is turning. In other cases, the LEDs may emit a bright red light to indicate that user of main unit 600 is slowing down or braking. In one such embodiment, an input received from an accelerometer and/or a G-sensor may trigger the color and/or intensity of light emitted by the dual-color LEDs to vary. It should be noted that the LEDs of main unit 600 may also be used to provide a visual warning of any impending danger to the user of main unit 600. While not shown, it is contemplated that the main unit 600 also includes provisions to provide haptic or audible warnings to the user of main unit 600.

FIG. 7 illustrates a rear view of main unit 600. As shown, the rear portion of main unit 600 includes one or more ports 701 (e.g., USB, THUNDERBOLT, etc.), switches 702, and vents 703. Vents 703 may allow for air flow through the main unit 600, for instance, to cool the main unit 600. Further, the one or more switches 702 may be connected to the power device of the main unit and may be used to power on or off the main unit 600. While depicted as bean shaped or elliptical, it should be noted that the main unit 600 may be in any shape or size.

What is claimed is:

1. A detection system coupled to a vulnerable object, the detection system comprising a main unit, the main unit comprising:
an enclosure;
a power device, wherein the power device supplies electrical power to the main unit;
one or more hardware processors configured by machine-readable instructions, a central processing unit, and one or more of an internal memory device and a storage device;
a wireless transmitter for exchanging data with at least one of a first object, a computing device, and another vulnerable object;
a communication device for communicating with at least one of a radar unit and a computing device, wherein the communication device communicates with the at least one of the radar unit and the computing device using at least one of Bluetooth, Bluetooth Low Energy, Wi-Fi, cellular, and Near Field Communication,
wherein the radar unit comprises one or more antennas and at least one of a millimeter wave and Extremely High Frequency transceiver for detecting the first object based at least in part on millimeter wave or Extremely High Frequency radio frequencies, and wherein the radar unit transmits an indication of the first object to the main unit via the wireless transmitter or the communication device, and
at least one of an optical sensor, a laser, an accelerometer, and an alarm.

2. The detection system of claim 1, wherein the vulnerable object comprises a person or a transportation unit selected from a group consisting of a bicycle, a motorcycle, a moped, a scooter, skateboard, roller blades, roller skates, and hoverboard.

3. The detection system of claim 1, wherein
the first object comprises a vehicle;
the indication comprises data related to a potential collision between the vulnerable object and the vehicle; and
the wireless transmitter comprises a vehicle-to-vehicle transmitter for transmitting the indication to the vehicle.

4. The detection system of claim 1, wherein the central processing unit receives one or more of accelerometer data, mm-wave radar data, optical data, laser data, time data, and global positioning data and provides real-time object detection based on the one or more of the accelerometer data, mm-wave radar data, optical data, laser data, time data, and global positioning data.

5. The detection system of claim 1, wherein
the main unit further comprises a graphics processing unit; and
the graphics processing unit renders images based in part on data received from the central processing unit.

6. The detection system of claim 1, wherein
the main unit relays real-time data to the computing device via the communication device; and
the computing device comprises one or more of a smartphone, a laptop, a tablet, and an augmented near-eye device.

7. The detection system of claim 6, further comprising an edge computer, wherein
the computing device further comprises a long-range low-latency connectivity device for transmitting information pertaining to the vulnerable object, and wherein
the information comprises at least a vulnerable object type and a location of the vulnerable object to the edge computer.

8. The detection system of claim 1, wherein the main unit further comprises one or more sensors, the one or more sensors including at least one of a positioning sensor, a visual sensor, a movement sensor, and an infrared sensor.

9. The detection system of claim 1, wherein
the accelerometer comprises an alternating current-response accelerometer, a direct current-response accelerometer, or a gravity sensor accelerometer;
the central processing unit receives accelerometer data and identifies that a collision has occurred based at least in part on detecting that an acceleration or deceleration has exceeded a threshold.

10. The detection system of claim 9, wherein
the wireless transmitter transmits an indication of the collision to emergency services or an emergency contact upon identifying that the collision has occurred; and
the main unit identifies a crash severity level associated with the collision based at least in part on analyzing one or more of accelerometer data, optical data, and radar data.

11. The detection system of claim 1, wherein
the main unit further comprises a graphics processing unit;
the optical sensor obtains visual data; and
at least one of the central processing unit and graphics processing unit of the main unit accesses a detection grid and warning system and analyzes the visual data in association with the detection grid and warning system.

12. The detection system of claim 11, wherein
the optical sensor comprises at least one of a rear-facing, a side-facing, and a forward-facing optical sensor; and
the main unit identifies at least one of an approach angle and a velocity of the first object based at least in part on the visual data.

13. The detection system of claim 1, wherein
the alarm provides a warning to a user of the vulnerable object; and
the warning comprises one or more of an audible warning, a haptic warning, and a visual warning.

14. The detection system of claim 1, wherein the main unit transfers obtained data to a cloud-based database utilizing a deep learning algorithm.

15. The detection system of claim 1, wherein the main unit identifies at least one of an approach angle and a velocity of an approaching object based at least in part on information obtained from the laser.

16. The detection system of claim 1, wherein
the main unit further comprises at least one of forward-facing and rear-facing LEDs; and
the at least one of forward-facing and rear-facing LEDs provide a visual warning.

17. The detection system of claim 1, wherein
the main unit alters a course of the vulnerable object based at least in part on detecting a potential collision with the first object; and
the altering comprises at least one of engaging one or more brakes of the vulnerable object, adjusting a steering of the vulnerable object, and engaging a forward propulsion system of the vulnerable object.

18. The detection system of claim 1, wherein
the first object comprises an approaching object;
the main unit maps object detection data comprising a velocity and a location of the approaching object onto an object detection grid comprising one or more detection zones, and wherein the main unit identifies a warning or a danger level based at least in part on the mapping.

19. A non-transitory, tangible computer readable storage medium, encoded with processor readable instructions, the instructions being executable by one or more processors to perform a method for detecting a potential collision with a vulnerable object, the method comprising:
coupling a vehicle object detection system to the vulnerable object, wherein the vehicle object detection system comprises a main unit comprising an enclosure, a power device, a central processing unit, a wireless transmitter, a communication device, a radar unit comprising one or more antennas and at least one of a millimeter wave and an Extremely High Frequency transceiver, and one or more of an internal memory device, a storage device, an optical sensor, a laser, an accelerometer, and an alarm;
configuring the radar unit to detect the potential collision based at least in part on millimeter wave or Extremely High Frequency radio frequencies;
configuring the communication device to communicate with one or more of the radar unit, the wireless transmitter, and a computing device using at least one of Bluetooth, Bluetooth Low Energy, Wi-Fi, cellular, and Near field Communication;
configuring the wireless transmitter to exchange data with at least one of a first object, an edge computer, and another vulnerable object;
transmitting, from the radar unit, an indication of the potential collision to the main unit via the wireless transmitter or the communication device; and
exchanging, from the wireless transmitter or the main unit, the indication of the potential collision with the first object to at least one of the first object and the edge computer, based at least in part on the transmitting.

20. A method for detecting a potential collision with a vulnerable object, the method comprising:
coupling a vehicle object detection system to the vulnerable object, wherein the vehicle object detection system comprises a main unit comprising an enclosure, a power device, a central processing unit, a wireless transmitter, a communication device, a radar unit comprising one or more antennas and at least one of a millimeter wave and an Extremely High Frequency transceiver, and one or more of an internal memory device, a storage device, an optical sensor, a laser, an accelerometer, and an alarm;
configuring the radar unit to detect the potential collision based at least in part on millimeter wave or Extremely High Frequency radio frequencies;
configuring the communication device to communicate with one or more of the radar unit, the wireless transmitter, and a computing device using at least one of Bluetooth, Bluetooth Low Energy, Wi-Fi, cellular, and Near field Communication;
configuring the wireless transmitter to exchange data with at least one of a first object, an edge computer, and another vulnerable object;
transmitting, from the radar unit, an indication of the potential collision to the main unit via the wireless transmitter or the communication device; and
exchanging, from the wireless transmitter or the main unit, the indication of the potential collision with the first object to at least one of the first object and the edge computer, based at least in part on the transmitting.
